(19) United States
(12) Patent Application Publication
(10) Pub. No.: US 2022/0172048 A1
(43) Pub. Date: Jun. 2, 2022

(54) METHOD AND SYSTEM FOR LEARNING REPRESENTATIONS LESS PRONE TO CATASTROPHIC FORGETTING

(71) Applicant: NAVER CORPORATION, Seongnam-si (KR)

(72) Inventors: Diane LARLUS, La Tronche (FR); Riccardo VOLPI, Grenoble (FR); Gregory ROGEZ, Gières (FR)

(21) Appl. No.: 17/514,698

(22) Filed: Oct. 29, 2021

(30) Foreign Application Priority Data
Nov. 27, 2020 (EP) 20306458.9

(51) Int. Cl. G06N 3/08; G06K 9/62; G06T 3/60

(52) U.S. Cl. CPC G06N 3/08; G06T 3/60; G06K 9/6257; G06K 9/6262

(57) ABSTRACT

Methods for training a neural network model for sequentially learning a plurality of domains associated with a task. At least one set of auxiliary model parameters is determined by simulating at least one first optimization step based on a set of current model parameters and at least one auxiliary domain associated with a primary domain comprising one or more data points. A set of primary model parameters is determined by performing a second optimization step based on the current model parameters and the primary domain and on the at least one set of auxiliary model parameters and the primary domain and/or the auxiliary domain. The model is updated with the set of primary model parameters.

### PRIORITY CLAIM AND REFERENCE TO RELATED APPLICATION

This application claims priority to European Patent Office Application No. EP20306458, filed Nov. 27, 2020, and entitled “Method for Learning Representations Less Prone to Catastrophic Forgetting.” European Patent Application No. EP20306458 is incorporated by reference herein in its entirety.

### FIELD

The present disclosure relates generally to machine learning, and more particularly to methods and systems for training processor-based models for continual learning.

### BACKGROUND

Modern machine learning approaches can reach super-human performance in a variety of isolated tasks at the expense of versatility. When confronted with a plurality of new tasks or new domains (e.g., datasets or data distributions), neural networks have trouble adapting, or adapt at the cost of forgetting what they had been initially trained for. This long-observed phenomenon (e.g., see David Lopez-Paz and Marc'Aurelio Ranzato: “Gradient Episodic Memory for Continual Learning”, in Proceedings of Advances in Neural Information Processing Systems (NIPS), 2017), is known as catastrophic forgetting.

Lifelong learning or continual learning approaches have thus been introduced to continually learn from new information without undesirably forgetting the past. Most of these approaches prevent new learning from interfering catastrophically with the old learning by using a memorization process that stores past information, or by dynamically modifying the architectures to capture additional knowledge. However, in practice, these solutions may not be appropriate in certain scenarios such as when retaining data is not allowed (e.g., due to privacy concerns) or when working under strong memory constraints (e.g., in mobile applications).

Accordingly, it would be desirable to provide learning representations that are robust against catastrophic forgetting. It would further be desirable to provide learning representations that do not necessarily require architecture modification, information storage, or complex heuristics to remember old patterns. Further, in view of the problem of continual and supervised adaptation to new domains, it would be desirable to provide and/or train a model that learns a given task and adapts to conditions that continually (e.g., constantly) change throughout its lifespan. This is of particular benefit, for instance, when deploying applications to real-world scenarios where a model is expected to adapt and can encounter different domains from the one observed at training time.

It is therefore desirable to provide an improved method for training a model that overcomes the above disadvantages of the prior art. It is further desirable to provide an efficient training method for a model that accurately performs on old data domains when being fine-tuned to new domains and/or when not having access to the old domains during the fine-tuning.

### SUMMARY

Provided herein, among other things, are methods and systems for training a model for continual learning. Example models include neural network models implemented by a processor and memory.

In an embodiment, a computer-implemented method for training a model comprises determining at least one set of auxiliary model parameters by simulating at least one first optimization step (e.g., at least one first gradient descent step) based on a set of current model parameters and at least one auxiliary domain. The at least one auxiliary domain is associated with a primary domain comprising one or more data points for training a model. A set of primary model parameters is determined by performing a second optimization step (e.g., a second gradient descent step) based on the set of current model parameters and the primary domain and based on the at least one set of auxiliary model parameters and at least one of the primary domain and the at least one auxiliary domain. The model is updated with the set of primary model parameters.

By determining a set of primary model parameters based at least in part on such auxiliary model parameters, an efficient method for training a robust model can be provided whose performance drop on old domains is mitigated when being fine-tuned to new domains and, if needed, without having access to the old domains during the fine-tuning. For instance, retaining data may not be allowed (e.g., due to privacy or security concerns) or when working under strong memory constraints (e.g., in mobile applications).

Example methods may further comprise generating the at least one auxiliary domain from the primary domain. Generating of the at least one auxiliary domain from the primary domain may comprise modifying the one or more data points of the primary domain via data manipulation. The at least one auxiliary domain may comprise the one or more modified data points. Generating of the at least one auxiliary domain from the primary domain may comprise selecting the one or more data points from the primary domain. The data manipulation may be performed automatically. Modifying of the one or more data points of the primary domain via data manipulation may comprise automatically and/or randomly selecting one or more transformations from a set of transformations, wherein each auxiliary domain of the at least one auxiliary domain is defined by one or more respective transformations of the set of transformations.

In example methods, the data manipulation may comprise at least one image transformation. The at least one image transformation may comprise a photometric and/or a geometric transformation.

By generating the at least one auxiliary domain from the primary domain, efficient methods can be provided that can simulate additional (auxiliary) domains based on a current domain. The additional (auxiliary) domains allow training of a model that can accurately perform on old data domains when being fine-tuned to new domains without having access to the other domains than the current domain.

Among other benefits, this saves memory space, since no information storage regarding the old training or model, no storage of data points of domains that have previously been used for training, and no complex heuristics to remember old patterns may be required.

In example methods, a loss function may be associated with the second optimization step. The example loss function may comprise (i) a first loss function associated with the set of current model parameters and the primary domain, and at least one of (ii) a second loss function associated with the at least one set of auxiliary model parameters and the primary domain, and (iii) a third loss function associated with the at least one set of auxiliary model parameters and the at least one auxiliary domain. A set of auxiliary model parameters of the at least one set of auxiliary model parameters may minimize a respective loss associated with a respective auxiliary domain of the at least one auxiliary domain with respect to the set of current model parameters. The set of primary model parameters may minimize a loss associated with the at least one set of auxiliary model parameters and at least one of the primary domain and the at least one auxiliary domain with respect to the current model parameters.

In example methods, the model may be initialized. Initializing the model may comprise, for instance, setting model parameters of a pre-trained model as initial model parameters for the model to fine-tune the pre-trained model. Determining at least one set of auxiliary model parameters, determining a set of primary model parameters, and updating the model may be repeated until one or more ending conditions have been met, such as but not limited to at least one of a gradient descent step size for the second optimization being below a threshold or a maximum number of gradient descent steps being reached. A gradient descent step may be proportional to a gradient (or approximate gradient) of a loss function at a current point.

According to example methods, the model may be trained on data points of the primary domain being a first primary domain in a first step, and the trained model may subsequently be trained on data points of a second primary domain in a second step. In some example methods, the second step can be performed without accessing data points of the first primary domain. The one or more data points of the primary domain may comprise or may be divided into a first set of data points for training the model, a second set of data points for validating the model, and a third set of data points for testing the model. The model may be trained in example methods by, for instance, empirical risk minimization (ERM).

In a further embodiment, a computer-readable storage medium having computer-executable instructions stored thereon is provided. When executed by a processor (which may be embodied in one or more processors), the computer-executable instructions cause the processor to perform the method for training a model described above and provided elsewhere herein.

In a further embodiment, a system comprising processing circuitry is provided. The processing circuitry is configured to perform the method for training a model described above and provided elsewhere herein.

Other embodiments provide, among other things, a system for training a model is provided. The system can be implemented by a processor and a memory. The system is configured to perform the method for training a model described above. Neural network models implemented by a processor and memory and trained according to example methods are further provided.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 is a process flow diagram of a method for training a model in accordance with at least one embodiment.

FIG. 2 illustrates an example life cycle of a model when training for continual domain adaptation.

FIGS. 3A(1), 3A(2) and 3B illustrate test results in accordance with embodiments.

FIG. 4 illustrates an example architecture in which example methods may be performed.

In the drawings, reference numbers may be reused to identify similar and/or identical elements.

### DETAILED DESCRIPTION

Systems and methods for training a model are provided herein. For purposes of explanation, numerous examples and specific details are set forth in order to provide a thorough understanding of the described embodiments. Embodiments as defined by the claims may include some or all of the features in these examples alone or in combination with other features described below and may further include modifications and equivalents of the features and concepts described herein. The illustrative embodiments will be described with reference to the drawings wherein elements and structures are indicated by reference numbers. Further, where an embodiment is a method, steps and elements of the method may be combinable in parallel or sequential execution. As far as they are not contradictory, all embodiments described below can be combined with each other.

Lifelong learning, also commonly referred to as continual learning, can involve continually learning new classes, new tasks, or new domains. In all cases, the corresponding approaches try to avoid forgetting previously learned patterns throughout the lifespan of a model. The latter case relates to scenarios where the domain sequentially changes but the task remains the same. Conventional learning approaches lead to fragile models, which are prone to drift when exposed to samples of a different nature. This is known in the art as catastrophic forgetting.

Novel meta-learning strategies that limit catastrophic forgetting and facilitate adaptation to new domains are disclosed. Novel training approaches that can easily be applicable when a model needs to be sequentially adapted to different domains are provided in example methods and systems herein. Example meta-learning methods provided herein are based on the concept of “auxiliary domains”.

Example training methods may include designing effective auxiliary domains (auxiliary datasets) that significantly improve adaptation to more diverse domains. Further, training methods may include “learning to optimize” strategies that can be effective, e.g., in few-shot learning.

As a nonlimiting continual learning example for computer vision related tasks, similar to all methods addressing continual learning, the need of re-training a new (e.g., computer vision) model from scratch every time new data points become available can be avoided. This is more efficient in terms of memory and of computational cost. This further can provide a reduced number of GPU-hours for training, and hence a positive environmental impact.

Moreover, unlike most conventional continual learning strategies, example methods do not require storing previously encountered training samples. For example, one might desire or even be legally required to delete sensitive data after the model has processed them. A model trained in accordance with example methods can be explicitly designed for this scenario. This approach can be useful for situations or environments where privacy or memory constraints are strong, and a small decrease in accuracy has only limited consequences.

For computer-vision related tasks (as a nonlimiting example application), transformations, such as image transformations, can be used as a good proxy for simulating or generating meta-domains. Meta-learning generally relies on a series of meta-train and meta-test splits, and an optimization process enforces that a few gradient descent steps on the meta-train splits lead to a generalization performance on the meta-test.

Lifelong learning can be provided by training a model with a loss that penalizes catastrophic forgetting and encourages adaptation to new domains without replaying old data or increasing the model capacity overtime. A two-fold regularizer can be provided that, on the one hand, encourages models to remember previously encountered domains when exposed to new ones (e.g., by means of optimization updates, such as gradient descent updates, on these tasks), and on the other hand, encourages an efficient adaptation to such domains. In contrast, prior art solutions that rely on meta-learning to handle continual learning problems require access to either old memories or training data streams.

Meta-learning and regularization strategies are disclosed that can force a model to train for a task of interest on a current domain, while learning to be resilient to potential domain shifts. To achieve this, optimization steps, such as gradient descent steps, can be simulated to optimize objectives slightly different from a main objective, and to encourage a loss associated with the current domain to remain low, thus avoiding catastrophic forgetting.

While meta-learning approaches typically require access to a number of different meta-tasks (or meta-domains), in some scenarios this access is not possible or allowed and only access to samples from the current domain is allowed for training a model. Artificial meta-domains can be used in example methods that are produced, e.g., automatically, by perturbing samples from an original distribution with data transformations. For computer vision or other image processing tasks, as a nonlimiting example, meta-domains may be obtained using, for instance, standard or other image manipulations.

Example methods allow training of a model for performing a task to efficiently adapt to new domains. Both resilience to catastrophic forgetting and efficient adaptation can be addressed by example meta-learning methods. In some example methods, models such as neural network models can be trained by optimizing an objective that takes into account (i) the loss associated with the current domain, (ii) the loss associated with the current domain after some gradient updates on new artificial domains, and (iii) a term to foster adaptation.

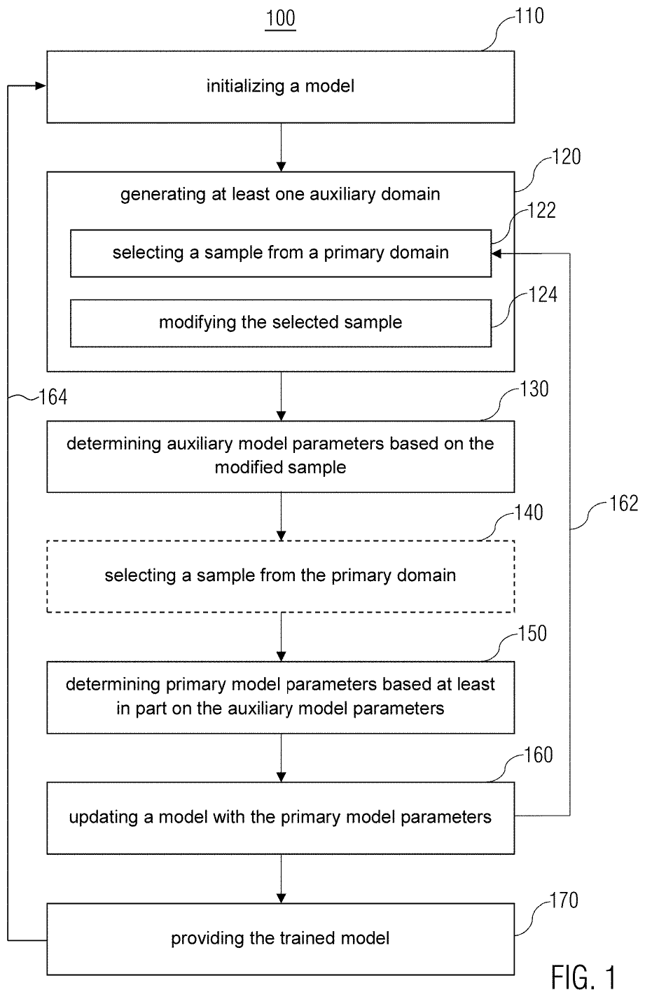

Referring now to the drawings, FIG. 1 illustrates an exemplary method 100 for training a model (e.g., a neural network model) in accordance with an embodiment. The method 100 for training a model may be, for instance, a method for learning a task in a plurality of domains sequentially provided during training.

The method 100 includes initializing the model at 110. The model may be initialized, for instance, by setting model parameters of a pre-trained model as initial model parameters for the model to fine-tune the pre-trained model. Alternatively, the model may be initialized by setting random or otherwise generated numbers for the model parameters of the model. Model parameters may include weights and/or biases of the model.

In step 120, at least one auxiliary domain is generated from a primary domain, which is embodied in or includes a set of data points from any suitable local, external, remote, or otherwise accessible source. For example, generating the at least one auxiliary domain from the primary domain may include selecting at 122 one or more data points from the primary domain. The selected one or more data points may be modified via data manipulation at 124. For example, all data points of the primary domain may be selected and modified prior to the following (e.g., optimization) steps. Alternatively, only some of the data points of the primary domain may be selected and modified prior to the following steps. For example, only the data points of the primary domain that are used for a current optimization step may be modified, and new or different data points of the primary domain may be modified subsequently prior to a next optimization step.

The at least one auxiliary domain can include the one or more modified data points. Modifying the one or more data points of the primary domain via data manipulation may include, for instance, automatically and/or randomly selecting one or more transformations from a set of transformations. Each auxiliary domain of the at least one auxiliary domain may be defined by one or more respective transformations of the set of transformations. For example, a plurality of basic transformations may be combined to obtain modified data points for an auxiliary domain defined by the combination of the plurality of basic transformations. The data manipulation or modification may be performed automatically, periodically, in response to one or more commands, inputs, events, etc.

For example, where the data set in the primary domain includes image data, the data manipulation can include at least one image transformation. The image transformation can include, for instance, a photometric and/or a geometric transformation. For example, the set of transformations may include one or more of a brightness transformation, a color transformation, a contrast transformation, a RGB-rand transformation, a solarize transformation, a grayscale transformation, a rotate transformation, a Gaussian noise transformation, and a blur transformation. As another example, for text or token-based data (e.g., for language processing tasks), one or more tokens may be transformed.

At 130, at least one set of auxiliary model parameters are determined by simulating at least one first optimization step, such as at least one gradient descent step, based on a set of current model parameters and at least one auxiliary domain. The at least one auxiliary domain is associated with the primary domain including the one or more data points. For instance, the auxiliary domain may include modified data points generated using one or more data points of the primary domain, as disclosed above. The data points of the primary domain and the modified data points included in the auxiliary data domain can be used for the training of the model.

For example, the at least one set of auxiliary model parameters may be determined based a set of current model parameters and one or more data points, such as a single sample or a batch of samples, of the auxiliary domain. Simulating at least one first optimization step may include, for instance, evaluating the regions, defined by the at least one set of auxiliary model parameters, in the weight/parameter space to calculate loss values associated with the primary task. However, the at least one set of auxiliary model parameters are not actually set as new model parameters of the model.

Optionally, at 140, a second sample or batch of samples may be selected for a second optimization step discussed in more detail below. The second sample or batch of samples may be different from the one or more data points selected at 122. Alternatively, the second sample or batch of samples may include the data points selected at 122 or a subset thereof. The same data points selected at 122 can be used for the second optimization step.

At 150, a set of primary model parameters is determined based at least in part on the auxiliary model parameters. For example, the set of primary model parameters may be determined by performing a second optimization step, such as a gradient descent step, based on the set of current model parameters and the primary domain, and based on the at least one set of auxiliary model parameters and at least one of the primary domain and the at least one auxiliary domain.

A loss function may be associated with the second optimization (e.g., gradient descent) 150. The loss function may include (i) a first loss function associated with the set of current model parameters and the primary domain, as well as at least one of (ii) a second loss function associated with the at least one set of auxiliary model parameters and the primary domain and (iii) a third loss function associated with the at least one set of auxiliary model parameters and the at least one auxiliary domain.

A set of auxiliary model parameters of the at least one set of auxiliary model parameters minimizes a respective loss associated with a respective auxiliary domain of the at least one auxiliary domain with respect to the set of current model parameters. The set of primary model parameters minimizes a loss associated with the at least one set of auxiliary model parameters and at least one of the primary domain and the at least one auxiliary domain with respect to the current model parameters.

The data points or samples for the optimization steps 130, 150 may be identically and independently distributed (i.i.d.) samples or data points. For example, a first sample or a first batch of samples may be selected from the auxiliary domain for first optimization step 130 including the determining at least one set of auxiliary model parameters. A second sample or a second batch of samples may be selected from the primary domain for the determining a set of primary model parameters, as well as at least one of a third sample or a third batch of samples selected from the primary domain and a fourth sample or a fourth batch of samples selected from the at least one auxiliary domain in second optimization step 150. Some or all of the first, second and third samples or batches of samples may be the same or different.

At 160, the model including the current model parameters is updated with the set of determined primary model parameters. As indicated by arrow 162 at least some steps are typically repeated during the training of the model, e.g., until one or more stopping criteria has been met. For example, the first optimization 130, second optimization 150, and model updating 160 may be repeated until a step size for the second optimization is below a threshold and/or a maximum number of steps is reached. Other stopping criteria may be used. Additionally, the sample selecting 122 and modifying 124 may also be repeated to generate a new and/or different sample or batch of samples including modified data points of the primary domain for a subsequent optimization step. Alternatively, when all data points of the primary domains are modified prior to first optimization 130, selecting a new and/or different sample or batch of samples from the auxiliary domain may be repeated until at least one of a step size for the second optimization is below a threshold and a maximum number of steps is reached, or if other stopping criteria is reached.

In step 170, the training may be completed (e.g., stopping criteria is reached). The updated model parameters obtained in the most recent second optimization step 150 define the trained model.

Although method 100 illustrates a meta-training training method for a model on one primary domain, the model can subsequently be trained on further and/or different primary domains. For example, the model may be trained on the one or more data points of the primary domain being a first primary domain in a first stage, and, as shown by arrow 164, the trained model may subsequently be trained or fine-tuned on data points of a second primary domain in a second stage. This subsequent training may occur, e.g., without accessing data points of the first primary domain in the second stage. The training in the second stage and/or any subsequent stage after that may be performed according to method 100.

The model may be trained by, for instance, empirical risk minimization (ERM). The one or more data points of the primary domain may be divided into a first set of data points for training the model, a second set of data points for validating the model and a third set of data points for testing the model.

The example method 100 allows for continual domain adaptation and mitigates the performance drop of a model on past domains while facing new ones. Transformations or other data modification methods can be used to efficiently generate data points that provide automatically or otherwise produced meta-domains. Experiments show that example meta-learning methods improves over simply using these data points in a standard data augmentation fashion.

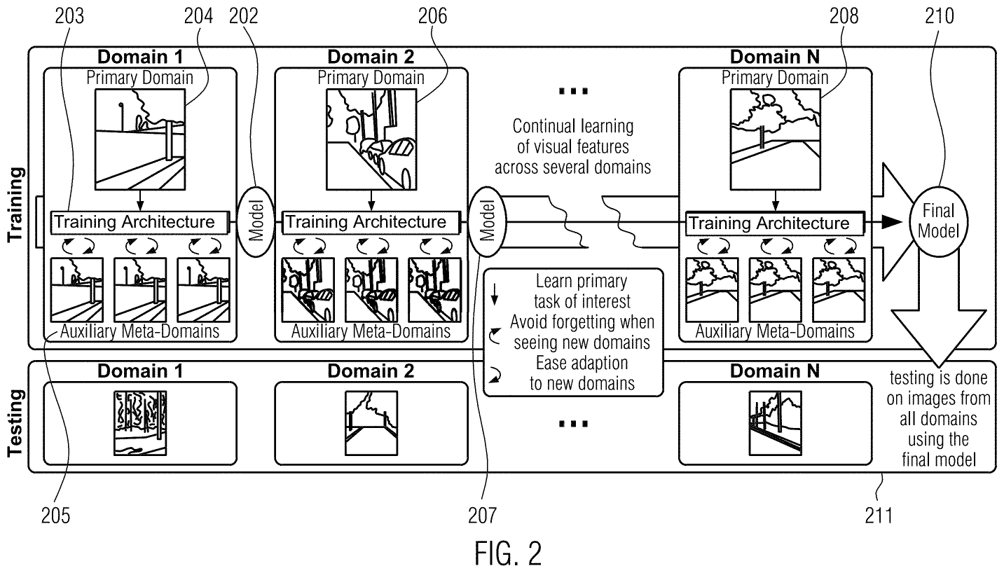

FIG. 2 illustrates a life cycle of a model 202, e.g., for performing one or more tasks, that may be used for continuous learning. The model 202 can be trained by sequentially exposing the model to a series of different domains 204-208. For tasks involving image processing, for instance, a domain may include a plurality of labeled images. For tasks involving language processing, as another nonlimiting example, the domain may include a plurality of labeled texts or documents.

The training may comprise meta-learning to overcome catastrophic forgetting. For example, a regularizer that can be used during the training, examples of which are provided in more detail below, may penalize the loss associated with a current domain 204 when the model 202 is transferred to one or more new domains (e.g., Primary Domain 204 (Domain 1) associated with model 202, Primary Domain 206 (Domain 2) associated with model 207, and Primary Domain 208 (Domain N) associated with model 210), while also easing adaptation. As explained above, the need for additional sources during training, which characterizes meta-learning methods, can be overcome by relying on artificial auxiliary domains, which can be crafted via (e.g., simple) data transformations.

In the example life cycle of the model 202, at every newly encountered domain (e.g., Domain 1, Domain 2, . . . , Domain N), the training architecture 203 according to an embodiment (e.g., using training method 100) is applied to the training set of that domain (e.g., Primary Domain 204) and on the generated auxiliary meta-domains (e.g., Auxiliary Meta-Domains 205). A final model (e.g., Final Model 210) may be evaluated on test data (as illustrated, images) from all the encountered domains (e.g., test images 211) to evaluate resilience to catastrophic forgetting.

In the example life cycle shown in FIG. 2, the model 202 is sequentially trained for the task of visual feature recognition of streets across multiple domains (an example of an image processing task, and more particularly, an image classification task). At a first stage, the primary domain of streets in sunny weather 204 is trained, followed in subsequent stages by the primary domain of streets in rainy weather 206 and the primary domain of streets in foggy weather 208. The Final Model 210, though sequentially trained independently for each additional primary domain, is adapted to perform the task for each domain.

Generally, at each stage of training (as illustrated in FIG. 1 at 164), a model (e.g., Model 202) trained earlier on primary domains (e.g., Primary Domain 204) may be sequentially trained or fine-tuned (e.g., Model 207) on additional primary domains (e.g., Primary Domains 206 and 208) without accessing the earlier trained primary domains (e.g., Primary Domain 204). The model 202, 207, 210 trained at each stage is adapted to carry out a task associated with the earlier trained primary domain and any additional trained primary domain.

Advantageously, the training method shown in FIGS. 1 and 2 can prepare a model to be more resilient to catastrophic forgetting of earlier trained primary domains, as additional trained primary domains can be sequentially added independent of earlier trained primary domains using auxiliary meta-domains associated with each primary domain. For example, as shown in FIG. 2, auxiliary meta-domains 205 associated with primary domain 204 may be used to train the model 202 in advance of any subsequent training of additional Primary Domain 206 so that the model 207 is resilient to catastrophic forgetting of earlier trained Primary Domain 204, when trained on Primary Domain 206 independent of Primary Domain 204, such that the resulting model 207 is adapted to perform a task in both Primary Domains 204 and 206.

For further illustration, an example meta-training method will now be described formally. A model M_{θ}, such as a neural network, e.g., a deep neural network, can be trained to solve a task [symbol] , relying on some data points that follow a distribution [symbol] ₀. In many implementations, this distribution is unknown, but a set of samples S₀˜ [symbol] ₀ is Known. The model can be trained with supervised learning and m training samples S₀={(xᵢ,yᵢ)}ᵢ₌₁^{m}, where xᵢ and yᵢ respectively represent a data sample or data point and its corresponding label.

For example, the model can be trained by empirical risk minimization (ERM), optimizing a loss [symbol] (Θ). For the supervised training of a multi-class classifier, for instance, this loss can be the cross-entropy between the predictions of the model y and the ground-truth annotations y.

$${θ}_{{𝒥}_{0}}^{*} = {min}_{θ} \{ {ℓ}_{{𝒥}_{0}} ( {S}_{0} ; θ ) := - \frac{1}{m} \sum {y}_{i}^{T} log {\hat{y}}_{i} \} \qquad ( 1 )$$

While neural network models trained via ERM (carried out via gradient descent) have been very effective in a broad range of problems, they are prone to forget about their initial task when fine-tuned on a new one, even if the two tasks appear very similar at first glance.

In practice, this means that for a model M₀ with model parameters [symbol] trained on a first task [symbol] as a starting point to train for a different task [symbol] , the newly obtained model M₁ with model parameters [symbol] typically shows degraded performances on [symbol] . More formally, [symbol] ( [symbol] )> [symbol] ( [symbol] ). This undesirable property of deteriorating performance on the previously learned task is known as catastrophic forgetting.

In some embodiments, the task may remain the same when fine-tuning the model, but the domain may vary instead. The model may be sequentially exposed to a list of different domains. The model is able to adapt to each new domain without degrading its performance on the old ones. This is referred to as continual domain adaptation. Example model training methods herein can mitigate catastrophic forgetting for the trained models on previously seen domains.

More formally, given a task [symbol] that remains constant, the model may be exposed to and/or trained on a sequence of domains Dᵢ, i∈{0, . . . , T}, each characterized by a distribution [symbol] from which specific samples Sᵢ can be drawn. Accordingly, the problem of catastrophic forgetting mentioned above can be rewritten as [symbol] (θ_{D}_{ᵢ}_{→D}_{ᵢ₊₁}*)> [symbol] (θ_{D}_{ᵢ}*). Each set of samples S, may become unavailable when the next domain Dᵢ₊₁ with samples Sᵢ₊₁ is encountered. The performance of the model may be assessed at the end of the training sequence, and for every domain Dᵢ.

A naive approach to address the problem above is to start from the model Mᵢ obtained after training on domain Dᵢ and to fine-tune it using samples from Dᵢ₊₁. Due to catastrophic forgetting, this baseline will typically perform poorly on older domains i<T when it reaches the end of its training cycle. This can be regarded as an experimental lower bound.

In contrast, according to example training methods, a training objective includes, at the same time, the following goals: (i) learning a task of interest [symbol] ; (ii) mitigating catastrophic forgetting when the model is transferred to different domains; and (iii) easing adaptation to a new domain.

To achieve the second and the third goals above, a number of meta-domains can be accessed, which can be used to run meta-gradient updates (meta-optimizations) throughout the training procedure. The loss associated with both the original domain (the training data) and the meta-domains (described in more detail hereinbelow) can be enforced to be small in the points reached in the weight space, both reducing catastrophic forgetting and easing adaptation.

In some example scenarios, when dealing with domain Dᵢ the other domains Dₖ, k≠i cannot be accessed. Accordingly, the older domains cannot be used as meta-domains. This may be due to, as nonlimiting examples, privacy concerns or memory constraints. Instead, meta-domains such as provided by auxiliary domains as disclosed herein may be produced, e.g., automatically, using data modification, such as but not limited to standard image transformations. Different meta-domains D_{A}_{ⱼ}, may each be defined by a set of samples S_{A}_{ⱼ} and made available for the training of the model.

Training models, such as neural networks, typically involves a number of gradient descent steps to minimize a given loss (e.g., as shown in Eq. (1) for classification tasks). According to example methods, prior to every gradient descent step associated with the current domain, an arbitrary number of optimization steps may be simulated to minimize the losses associated with the given or available auxiliary domains. For example, a single gradient descent step can be run on each of K different domains at iteration t, which results in K different points in the weight space, defined as {θ_{Aj}^{t}=θ^{t}−α∇_{θ} [symbol] (S_{Aj};θ^{t})}ⱼ₌₁^{K}, where Aⱼ indicates the j-th auxiliary domain.

These weight configurations can be used to compute the loss associated with the primary domain (observed through the provided training set S₀) after adaptation, { [symbol] (S₀;θ_{Aj}^{t})}ⱼ₌₁^{K}. Minimizing these loss values via a (e.g., first) regularizer forces the model to be less prone to catastrophic forgetting. Their sum may be defined as [symbol] _{recall}.

Furthermore, loss values associated with the meta-domains, observed through the auxiliary sets S_{Aj}, { [symbol] (S_{Aj};θ_{Aj}^{t})}ⱼ₌₁^{K} can be computed and minimized via a (e.g., second) regularizer. Their sum may be defined as [symbol] _{adapt}. These losses can be combined in any possible combinations.

In example methods, all losses may be combined. Accordingly, the loss that is minimized at each step may be provided by:

$$ℒ := {ℒ}_{𝒥} ( {S}_{0} ; {θ}^{t} ) + \underbrace{β \frac{1}{K} {\sum }_{j = 1}^{K} {ℒ}_{𝒥} ( {S}_{0} ; {θ}_{Aj}^{t} )}_{{ℒ}_{recall}} + \underbrace{γ \frac{1}{K} {\sum }_{j = 1}^{K} {ℒ}_{𝒥} ( {S}_{Aj} ; {θ}_{Aj}^{t} )}_{{ℒ}_{adapt}} \qquad ( 2 )$$

The three terms of this objective can embody the goals (i), (ii) and (iii) described above (learning one task, avoiding catastrophic forgetting, and encouraging adaptation, respectively).

In the example above, only a single meta-optimization step is performed for each auxiliary domain. In this case, computing the gradients ∇_{θ} [symbol] (θ_{Aj}^{t}) involves the computation of a gradient of a gradient, since ∇_{θ} [symbol] (θ_{Aj}^{t})=∇_{θ} [symbol] (θ^{t}−α∇_{θ} [symbol] (θ^{t})). In example methods, multi-step meta-optimization procedures may be performed.

During example training methods, auxiliary domains D_{Aj} are accessed. In particular, auxiliary distributions [symbol] _{Aj} may be accessed, from which samples or sample data points can be obtained to run the meta-updates.

An arbitrary number of auxiliary domains can be created, for instance, by modifying data points from the original training set S₀ via data manipulations. For example, where the data points in a primary domain are images, by applying transformations, such as but not limited to photometric and/or geometric transformations, to images of a training set, new training samples can be generated.

The following examples will be described with respect to computer vision tasks, where image transformations are used to create the auxiliary domains. However, other data manipulations can be used for other tasks.

In an embodiment, a set of functions T is accessed, where each element of the set may be a specific transformation, or a specific transformation with a specific magnitude level (e.g., “increased brightness by 10%”). The set of functions may cover some or all possible transformations obtained by combining N given basic functions (e.g., with N=2, “increase brightness by 10% and then reduce contrast by 5%”). Given the so-defined set and a dataset S₀={(xᵢ,yᵢ)}ᵢ₌₁^{m}˜ [symbol] , novel data points can be generated by sampling an object from the set T_{Aj}˜Ψ, and then applying it to the given data points, obtaining S_{Aj}=f(T_{Aj}(xᵢ),yᵢ)ᵢ₌₁^{m}.

An example learning procedure is shown below.

Procedure 1: Training Procedure for a Single Domain

| | |
|---|---|
| Input: | auxiliary transformation set Ψ = {Tᵢ}_{i = 1}^{M}, training set S₀, initial weights |
| | θ⁰, hyper-parameters η (learning rate), α (meta-learning rate), β and |
| | γ |
| Output: | weights 0*^{= N} |

| 1. | Initialize θ ← θ⁰ | |
|---|---|---|
| 2. | for t = 1, ... , N do | |
| 3. | Sample (\hat{x}, ŷ) uniformly from S₀ | (Sample batch for meta-update) |
| 4. | Sample T_{A} uniformly from Ψ | (Sample current Auxiliary domain) |
| 5. | θ_{T}_{_{A}}^{t} ← θ^{t} − α∇_{θ} [symbol] (T_{A}(\hat{x}), ŷ; θ^{t}) | (Run meta-gradient step) |
| 6. | Sample (x, y) uniformly from S₀ | (Sample batch for update) |

| | |
|---|---|
| 7. | ${θ}^{t + 1} ← {θ}^{t} - η {∇}_{θ} \underbrace{( {ℒ}_{𝒯} ( x , y ; {θ}^{t} )}_{Current task} + \underbrace{β {ℒ}_{𝒯} ( x , y ; {θ}_{{T}_{A}}^{t} )}_{Backward transfer} + \underbrace{γ {ℒ}_{𝒯} ( {T}_{A} ( x ) , y ; {θ}_{{T}_{A}}^{t} ) )}_{Forward transfer}$ |
| | (Run gradient step) |

In the above example procedure, K has been set to 1, and loss defined in Eq. (2) is approached via gradient descent steps by randomly sampling one different auxiliary transformation prior to each step (T_{A} in line 4 represents the current auxiliary domain). For clarity of explanation, only one single gradient descent step is shown for the auxiliary tasks in the Procedure 1 box (line 4). However, it will be appreciated that the example procedure is general and can be implemented with an arbitrary number of gradient descent trajectories.

### Experiments

In experiments, protocols were defined to assess the effectiveness of example lifelong learning strategies for representative tasks embodied in computer vision tasks. In a variety of computer vision tasks, the experiments show that models trained in accordance with example meta-learning methods were less prone to forgetting when transferred to new domains, without either replaying old samples or increasing the model capacity over time.

A first experimental protocol concerns digit recognition, i.e., an image-level classification task. Although challenging, the small scale of the images and domain sets allows for an extensive ablative study. A second experimental protocol concerns semantic segmentation. By leveraging synthetic data for urban environments, the protocol considers arbitrary sequences of domains, including different cities and weather conditions, which one could observe in a real application. Benchmarks to assess example lifelong learning strategies for computer vision research, illustrating effectiveness of example meta-learning methods, are provided herein.

Experiments were conducted in accordance with example embodiments for meta-training a model for the task of digit recognition. Standard digit datasets broadly adopted by the computer vision community were used: MNIST (Yann Lecun, Leon Bottou, Yoshua Bengio, and Patrick Haffner: “Gradient-based learning applied to document recognition”, in Proceedings of the IEEE, pages 2278-2324, 1998), SVHN (Yuval Netzer, TaoWang, Adam Coates, Alessandro Bissacco, BoWu, and Andrew Y. Ng: “Reading digits in natural images with unsupervised feature learning”, in NIPS Workshop on Deep Learning and Unsupervised Feature Learning, 2011), MNIST-M and SYN (Yaroslav Ganin and Victor Lempitsky: “Unsupervised domain adaptation by backpropagation”, in Proceedings of the 36th International Conference on Machine Learning (ICML), 2015).

To assess lifelong learning performance, training trajectories included training on samples from one dataset in a first step, then training on samples from a second dataset in a second step, and so on. Given these four datasets, two distinct protocols, defined by the following sequences: MNIST→MNIST→M→SYN→SVHN and SVHN→SYN→MNIST→M→MNIST were assessed, referred to as P1 and P2, respectively. These allowed assessing performance on two different scenarios, respectively: starting from easy datasets and moving to harder ones, and vice-versa. Each experiment was repeated n=3 times and the averaged results and standard deviations were investigated.

For both protocols, a final accuracy was used on every test set as a metric (in [0, 1]), For compatibility, all images were resized to 32×32 pixels, and, for each dataset, 10,000 training samples were used. A standard PyTorch implementation of ResNet-18 is used in both protocols. The models were trained on each domain for N=3·10³ gradient descent steps, setting the batch size to 64. An Adam optimizer was used with a learning rate η=3·10⁻⁴, which was re-initialized η=3·10⁻⁵ after the first domain. For the example Procedure 1, parameters were set as β=γ=1.0 and α=0.1. One set of functions or transformations may comprise color perturbations Ψ₁, one also allowed for rotations Ψ₂, and one also allowed for noise perturbations Ψ₃.

In an experiment, the Virtual KITTI 2 (Yohann Cabon, Naila Murray, and Martin Humenberger: “Virtual KITTI 2”, arXiv:2001.10773 [cs.CV], 2020) dataset was used to generate sequences of domains. For example, 30 simulated scenes were provided, each corresponding to one of the 5 different urban city environments and one of the 6 different weather/daylight conditions. Ground-truth for several tasks was given for each data point. In this experiment, the semantic segmentation task was investigated.

In the experiment, the most severe forgetting occurred when the visual conditions changed drastically. For this reason, cases where an initial model had been trained on samples from a particular scene were adapted to a novel urban environment with different condition. In concrete terms, given three urban environments A, B, C sampled from five available environments, the learning sequences were Clean→Foggy→Cloudy (P1), Clean→Rainy→Foggy (P2) and Clean→Sunset→Morning (P3)—where by “clean” it is referred to as synthetic samples cloned from the original KITTI (Andreas Geiger, Philip Lenz, and Raquel Urtasun: “Are we ready for autonomous driving? the KITTI vision benchmark suite”, in Proceedings of the IEEE Conference on Computer Vision and Pattern Recognition (CVPR), 2012) scenes. For each protocol, n=10 different permutations of environments A, B, C were randomly sampled and mean and variance results were calculated.

Since Virtual KITTI 2 does not provide any default train/validation/test split, for each scene/condition the first 70% of the sequence were used for training, the next 15% for validation and the final 15% for testing. Samples were used from both cameras, and horizontal mirroring was used for data augmentation in every experiment. A U-Net architecture with a ResNet-34 backbone pre-trained on ImageNet may be used.

The model was trained for 20 epochs on the first sequence, and for 10 epochs on the following ones. The batch size was set to 8. An Adam optimizer was used with a learning rate η=3·10⁻⁴, which was re-initialized with η=3·10⁻⁵ after the first domain. In accordance with Procedure 1, the parameters for this experiment were β=γ=10.0 and α=0.01. A transformation set or a set of functions comprising transformations for color perturbations were used. A publicly available semantic segmentation suite was used that is based on PyTorch. The performance on every domain explored during the learning trajectory was assessed, using mean intersection over union (mIoU, in [0, 1]) as a metric.

For comparison, and as a counterpart to the naive baseline, which simply fine-tunes the model as new data come along, two oracle methods were considered. If the training method allows access to every domain at every point in time, models can either be trained on samples from the joint distribution from the beginning (P₀∪P₁ . . . ∪P_{T}, oracle (all)), or grow the distribution over iterations (first train on P₀, then on P₀∪P₁, etc., oracle (cumulative)). With access to samples from any domain, for what concerns assessing catastrophic forgetting, these oracles can serve the role of an upper bound for the experiments in this application.

Since image transformations are used to generate auxiliary domains, the naive baseline is enriched with such transformations using them as regular data augmentation during training (Naive+DA). Results in accordance with embodiments were compared with L2-regularization and EWC approaches, both introduced by Kirkpatrick (James Kirkpatrick, Razvan Pascanu, Neil Rabinowitz, Joel Veness, Guillaume Desjardins, Andrei A. Rusu, Kieran Milan, John Quan, Tiago Ramalho, Agnieszka Grabska-Barwinska, Demis Hassabis, Claudia Clopath, Dharshan Kumaran, and Raia Hadsell: “Overcoming catastrophic forgetting in neural networks”, PNAS, 2017). Note that, for a fair comparison, these procedures were implemented with the same data augmentation strategies that were used for creating the auxiliary domains in accordance with example methods.

Results

The results were averaged over 3 runs, and the models were trained using Ψ₃. The performance was evaluated on all domains at the end of the training sequence P1.

TABLE 1
Ablation study of the loss terms in Eq. (2) (diqits experiment)

| | | Training Protocol: P1 | | | |
|---|---|---|---|---|---|
| Losses | | MNIST | MNIST-M | SYN | SVHN |
| L_{recall} | L_{adapt} | (1) | (2) | (3) | (4) |
| | | .837 ± .064 | .688 ± .034 | .923 ± .004 | .869 ± .001 |
| X | | .943 ± .007 | .765 ± .006 | .944 ± .000 | .895 ± .892 |
| | X | .897 ± .005 | .746 ± .001 | .954 ± .001 | .919 ± .000 |
| X | X | .920 ± .006 | .751 ± .005 | .954 ± .003 | .919 ± .002 |

Table 1, above, shows results of an ablation study, where the performance was evaluated by including the different terms in the proposed loss (in Eq. (2)). The performance is listed for models trained via Procedure 1 on protocol P1. Accuracy values were computed after having trained on the four datasets. These results show that, in this setting, the first regularizer helps retaining performance on older tasks (cf. MNIST performance with and without L_{recall}). Without the second regularizer though, performance on late tasks is penalized (cf. performance on SYN and SVHN with and without L_{adapt}). The last row shows that the two regularizer terms do not conflict when used in tandem, allowing for good performance on early tasks while better adapting to new ones.

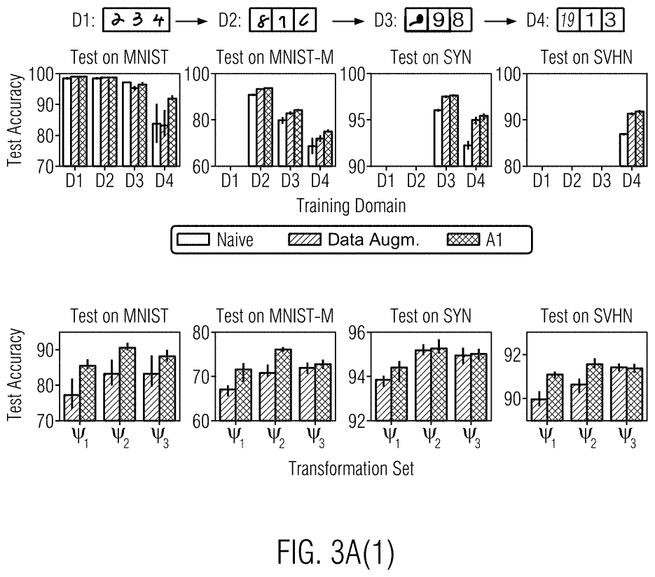

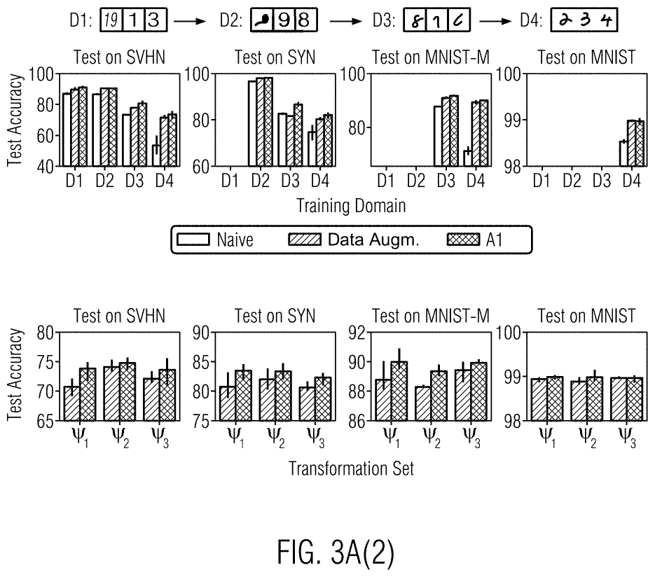

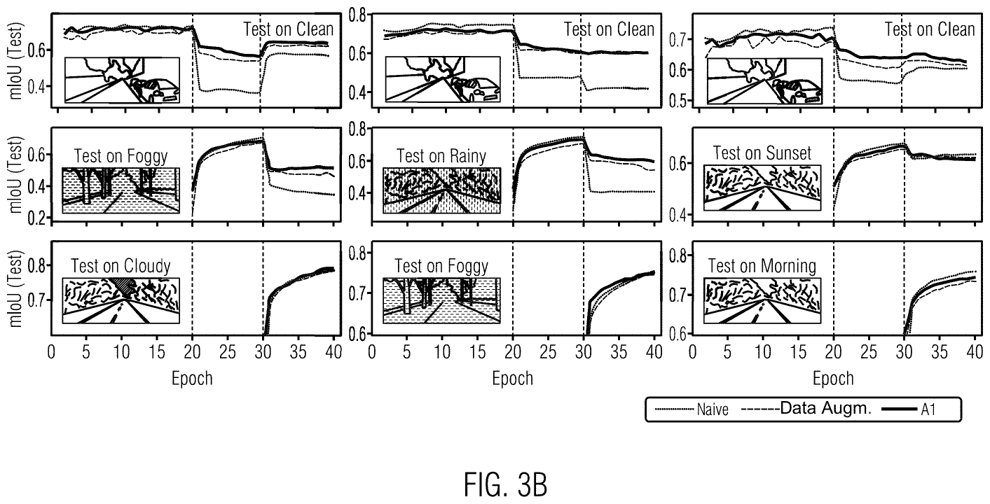

FIG. 3A(1) and FIG. 3A(2) show results related to protocols P1 (FIGS. 3A(1)) and P2 (FIG. 3A(2)) of digit experiments. Upper plots show the performance throughout the training sequence (after having trained on each of the four domains). Lower plots show performance at the end of the training sequence for different transformation sets Ti. The upper plot of FIG. 3A(1) and FIG. 3A(2) show how accuracy evolves as the model was fine-tuned on each of the different domains, for the two protocols (P1 and P2, in FIG. 3A(1) and FIG. 3A(2), respectively). Performance achieved with a model (A1) trained with the method according to an embodiment (A1, right bar of the three bars) was compared with the naive training procedure, with (Data Augm., middle bar) and without data augmentation (Naive, left bar). To disambiguate the contribution of the transformation sets from the contribution of the example method itself, the lower plots of FIG. 3A(1) and FIG. 3A(2) show the performance achieved with the support of different transformation sets to generate auxiliary domains.

FIG. 3B shows KITTI results on protocols P1, P2 and P3 (left, middle and right, respectively) for models trained via “native”, non-augmented (“ [symbol] ”), via “Data Augm.”, augmented naive baseline (“ [symbol] ”), and via “A1”, Procedure 1 (“ [symbol] ”). Curves were averaged across 10 random permutations of A, B, C environments. Table 3, below, shows the final numeric results. Results were benchmarked against the data augmentation baseline trained with the same sets. These results show that the example meta-learning strategy consistently outperformed the data augmentation baselines across several choices for the auxiliary set.

Table 2, below, shows a comparison between models trained with the example method, the augmented and non-augmented baselines, and the oracles and EWC/L2. The model obtained with the example method compared favorably with all non-oracle approaches. A testbed in which the method performed worse than a competing method is SVHN in protocol P2, where L2 regularization performed better. This may have been due to the fact that SVHN is a very complex domain already, with respect to the others, so it may have been less effective to simulate auxiliary domains from this starting point.

In Table 2, test accuracy results on MNIST, MNIST-M, SYN and SVHN are shown at the end of protocols P1 (left) and P2 (right). The model obtained with the example method indicates results obtained via Procedure 1. The same transformation set T₃ was used for the example method and for baselines that relied on data augmentation (DA). Oracles can access data from all domains at any time during training and, thus, perform better.

TABLE 2
Digits experiment: comparison

| Protocol P1 | | | | | Protocol P2 | | | |
|---|---|---|---|---|---|---|---|---|
| | MNIST | MNIST-M | SYN | SVHN | SVHN | SYN | MNIST-M | MNIST |
| Method | (1) | (2) | (3) | (4) | (1) | (2) | (3) | (4) |
| Naive | .837 ± | .688 ± | .923 ± | .869 ± | .540 ± | .749 ± | .711 ± | .985 ± |
| | .064 | .034 | .004 | .001 | .058 | .031 | .015 | .000 |
| Naive + DA | .834 ± | .720 ± | .950 ± | .914 ± | .723 ± | .808 ± | .895 ± | .990 ± |
| | .036 | .011 | .003 | .001 | .009 | .006 | .006 | .000 |
| L2 [21] + | .859 ± | .718 ± | .954 ± | .914 ± | .753 ± | .820 ± | .894 ± | .988 ± |
| DA | .028 | .018 | .002 | .001 | .014 | .013 | .009 | .000 |
| EWC [21] + | .872 ± | .707 ± | .954 ± | .918 ± | .733 ± | .805 ± | .898 ± | .988 ± |
| DA | .018 | .010 | .003 | .001 | .005 | .008 | .006 | .001 |
| Model of | .920 ± | .751 ± | .953 ± | .919 ± | .738 ± | .824 ± | .901 ± | .990 ± |
| embodiment | .006 | .005 | .003 | .002 | .021 | .011 | .001 | .001 |
| Oracle | .998 ± | .934 ± | .971± | .899 ± | .899 ± | .971 ± | .934 ± | .998 ± |
| (all) | .000 | .004 | .002 | .005 | .005 | .002 | .004 | .000 |
| Oracle | .998 ± | .933 ± | .966 ± | .886 ± | .902 ± | .970 ± | .925 ± | .985 ± |
| (cumul.) | .001 | .002 | .001 | .007 | .002 | .001 | .001 | .001 |

Table 3, below, shows results related to protocols P1, P2 and P3 (left, middle and right, respectively), and the respective curves in FIG. 3B from an experiment related to semantic scene segmentation. The table shows mean intersection over union (mIoU) results on the domains that characterize protocols P1, P2 and P3 at the end of the training sequences. N. and DA are the non-augmented and augmented baselines.

Procedure 1 (A1) was compared with augmented and non-augmented naive baselines (DA and N. rows, respectively). Also in these settings, heavy data augmentation proved to be effective to better remember the previous domains. In general, using Procedure 1 according to an example method allowed for better or comparable performance using the same transformation set. Models obtained with the example method were less effective when the domain shift was less pronounced (P3). In this case, neither data augmentation nor the model according to Procedure 1 provided the same benefit that could be observed in the other protocols, or in the experiment on digits (Table 2).

TABLE 3
Semantic segmentation results

| | Protocol P1 | | | Protocol P2 | | | Protocol P3 | | |
|---|---|---|---|---|---|---|---|---|---|
| | | Fog- | | | | Fog- | | Sun- | Morn- |
| | Clean | gy | Cloudy | Clean | Rainy | gy | Clean | set | ing |
| | (1) | (2) | (3) | (1) | (2) | (3) | (1) | (2) | (3) |
| N. | .566 ± | .345 ± | .787 ± | .413 ± | .403 ± | .753 ± | .603 ± | .636 ± | .760 ± |
| | .151 | .097 | .101 | .137 | .128 | .191 | .115 | .077 | .100 |
| DA | .619 ± | .461 ± | .787 ± | .596 ± | .538 ± | .754 ± | .614 ± | .623 ± | .734 ± |
| | .088 | .086 | .089 | .087 | .113 | .091 | .081 | .081 | .099 |
| A1 | .632 ± | .511 ± | .793 ± | .598 ± | .590 ± | .748 ± | .626 ± | .615 ± | .745 ± |
| | .078 | .081 | .103 | .088 | .105 | .096 | .092 | .087 | .112 |

Although the above embodiments have been described in the context of method steps, they also represent a description of a corresponding component, module or feature of a corresponding apparatus or system.

Some or all of the method steps may be implemented by a computer in that they are executed by (or using) a processor, a microprocessor, an electronic circuit or processing circuitry, which may incorporate or operate in combination with memory.

The embodiments described above may be implemented in hardware or in software. Implementations can be performed using non-transitory storage media such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

Generally, embodiments can be implemented as a computer program product with a program code or computer-executable instructions, the program code or computer-executable instructions being operative for performing one of the methods when the computer program product runs on a computer. The program code or the computer-executable instructions may be stored on a non-transitory computer-readable storage medium.

In an embodiment, a non-transitory storage medium, a data carrier, or a computer-readable medium may comprise, stored thereon, the computer program or the computer-executable instructions for performing one of the methods described herein when it is performed by a processor and memory. In a further embodiment, an apparatus may include one or more processors, a memory, and the storage medium mentioned above.

In a further embodiment, an apparatus may include means, for example processing circuitry such as, e.g., a processor communicating with a memory, the means being configured to, or adapted to perform, one of the methods described herein.

A further embodiment comprises a computer having installed thereon the computer program or instructions for performing one of the methods described herein.

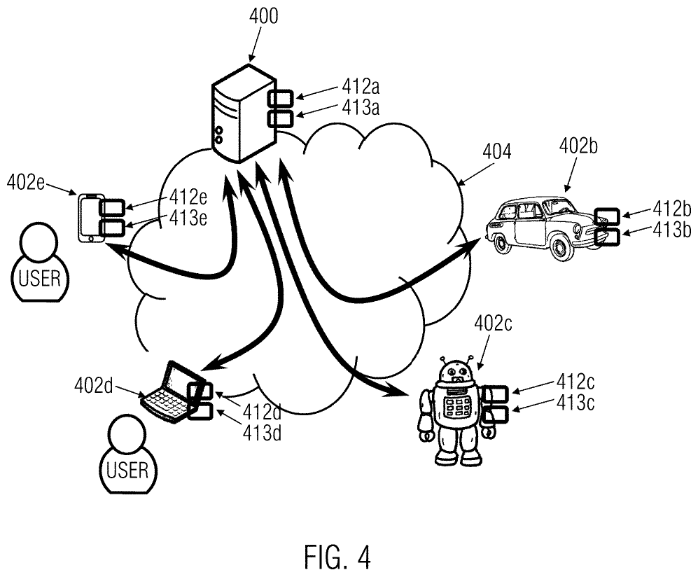

Methods provided herein may be implemented within an architecture (e.g., a network or system architecture) such as but not limited to that illustrated in FIG. 4, which includes a server 400 and one or more client devices 402 that communicate over a network 404 (which may be wireless and/or wired) such as the Internet for data exchange. Server 400 and/or the client devices 402 can include a data processor 412 and memory 413 such as but not limited to random-access memory (RAM), read-only memory (ROM), hard disks, solid state disks, or other non-volatile storage media. Memory 410 may also be provided in whole or in part by external memory or storage in communication with the processor 412. The client devices 402 may be any device that communicates with server 400.

Example methods may be implemented by a processor such as the processor 412 or other processor in the server 402 and/or client devices 402. It will be appreciated that the processor 412 can include either a single processor or multiple processors operating in series or in parallel. Memory used in example methods may be embodied, for instance, in memory 413 and/or suitable storage in the server 400, client devices 402b-e, a connected remote storage, or any combination. Memory can include one or more memories or memory elements or structures, including combinations of memory types and/or locations. Data in memory can be stored in any suitable format for data retrieval and processing.

Server 400 may include, but is not limited to, dedicated servers, cloud-based servers, or a combination (e.g., shared). Data streams may be communicated from, received by, and/or generated by the server 400 and/or the client devices 402b-e.

Client devices 402b-e may be any processor-based device, terminal, etc., and/or may be embodied in a client application executable by a processor-based device, etc. Client devices may be disposed within the server 402 and/or external to the server (local or remote, or any combination) and in communication with the server. Example client devices 402b-e include, but are not limited to, autonomous vehicle 402b, robot 402c, computer 402d, mobile communication devices (e.g., smartphones, tablet computers, etc.) such as smartphone 402e, as well as various processor-based devices not shown in FIG. 4 such as but not limited to virtual reality (VR), augmented reality (AR), or mixed reality (MR) devices, wearable computers, etc. Client devices 402b-e may be, but need not be, configured for sending data to and/or receiving data from the server 400, and may include, but need not include, one or more output devices, such as but not limited to displays, printers, etc. for displaying or printing results of certain methods that are provided for display by the server. Client devices may include combinations of client devices.

In an example training method, the server 400 or client devices 402b-e may receive input data from any suitable source, e.g., from memory 413 (as nonlimiting examples, internal storage, an internal database, etc.), from external (e.g., remote) storage connected locally or over network 404, etc. Data for new and/or existing data streams may be generated or received by the server 400 and/or client devices 402b-e using one or more input and/or output devices, sensors, communication ports, etc.

Example training and meta-training methods can generate an updated model that can be likewise stored in the server (e.g., memory 413), client devices 402a-d, external storage, or combination. In some example embodiments provided herein, training (which can include validation and/or testing) and/or inference may be performed offline or online (e.g., at run time), in any combination. Training may be or include a single training session, sequential learning, continual learning, or a combination (e.g., for different models, domains, tasks, etc. in example systems). Results of training and/or inference can be output (e.g., displayed, transmitted, provided for display, printed, etc.) and/or stored for retrieving and providing on request.

Example trained neural network models can be operated (e.g., during inference or runtime) by processors and memory in the server 400 and/or client devices 402b-e to perform one or more tasks. Nonlimiting example tasks include recognition tasks, classification tasks, retrieval tasks, question answering tasks, etc. for various applications such as, but not limited to, computer vision, autonomous movement, and natural language processing. During inference or runtime, for example, a new data input (e.g., representing text, voice, image, sensory, or other data) can be provided to the trained model (e.g., in the field, in a controlled environment, in a laboratory, etc.), and the trained model can process the data input. The processing results can be used in additional, downstream decision making or tasks and/or displayed, transmitted, provided for display, printed, etc.) and/or stored for retrieving and providing on request.

For instance, the training method according to the embodiment of FIG. 1 may be performed at server 400 for a task in a plurality of domains. As a nonlimiting example, the task may be the recognition of images or features of images in a domain (e.g., an image categorizer used by an application on robot 402c, autonomous vehicle 402b or cell phone 402e to identify streets in sunny weather, rainy weather, or foggy weather as shown in FIG. 2). Advantageously, the method may be used to add new domains or refine domains over time, while minimizing catastrophic forgetting of domains learned earlier in time. Other examples of tasks include but are not limited to natural language understanding, search, and translation. In other embodiments, the methods according to the embodiments of FIG. 1 may be performed at client devices 402b-e partially or completely. In yet other embodiments, the methods may be performed at a different server or on a plurality of servers in a distributed manner, or at a combination of servers and client devices.

General

Embodiments herein provide, among other things, a computer-implemented method for training a neural network model for sequentially learning a plurality of domains associated with a task, the computer-implemented method comprising: determining at least one set of auxiliary model parameters by simulating at least one first optimization step based on a set of current model parameters and at least one auxiliary domain, wherein the at least one auxiliary domain is associated with a primary domain comprising one or more data points for training a neural network model; determining a set of primary model parameters by performing a second optimization step based on the set of current model parameters and the primary domain and based on the at least one set of auxiliary model parameters and at least one of the primary domain and the at least one auxiliary domain; and updating the neural network model with the set of primary model parameters.

In example methods, in combination with any of the above features, the computer-implemented method may further comprise generating the at least one auxiliary domain from the primary domain, wherein the generating the at least one auxiliary domain from the primary domain comprises modifying the one or more data points of the primary domain via data manipulation, and wherein the at least one auxiliary domain comprises the one or more modified data points.

In example methods, in combination with any of the above features, the data manipulation may be performed automatically.

In example methods, in combination with any of the above features, the, and/or the generating the at least one auxiliary domain from the primary domain may comprise selecting the one or more data points from the primary domain.

In example methods, in combination with any of the above features, the modifying the one or more data points of the primary domain via data manipulation may comprise automatically and/or randomly selecting one or more transformations from a set of transformations, wherein each auxiliary domain of the at least one auxiliary domain is defined by one or more respective transformations of the set of transformations.

In example methods, in combination with any of the above features, the data manipulation may comprise at least one image transformation, and the at least one image transformation may comprise a photometric and/or a geometric transformation.

In example methods, in combination with any of the above features, the second optimization step employs a regularizer having a first objective of avoiding catastrophic forgetting and a second objective of encouraging domain adaptation.

In example methods, in combination with any of the above features, the second optimization step employs a loss function having terms associated with task learning, avoiding catastrophic forgetting, and encouraging domain adaptation.

In example methods, in combination with any of the above features, the loss function is used for optimization of the model via gradient descent.

In example methods, in combination with any of the above features, a loss function associated with the second optimization step comprises: (i) a first loss function associated with the set of current model parameters and the primary domain, and one or more of: (ii) a second loss function associated with the at least one set of auxiliary model parameters and the primary domain, or (iii) a third loss function associated with the at least one set of auxiliary model parameters and the at least one auxiliary domain.

In example methods, in combination with any of the above features, the method may further comprise initializing the neural network model, wherein initializing the neural network model comprises setting model parameters of a pre-trained neural network model as initial model parameters for the neural network model to fine-tune the pre-trained neural network model.

In example methods, in combination with any of the above features, the method may further comprise: selecting a first sample or a first batch of samples from the auxiliary domain for the determining at least one set of auxiliary model parameters, and selecting a second sample or a second batch of samples from the primary domain and at least one of selecting a third sample or a third batch of samples from the primary domain and selecting a fourth sample or a fourth batch of samples from the at least one auxiliary domain for the determining a set of primary model parameters.

In example methods, in combination with any of the above features, a set of auxiliary model parameters of the at least one set of auxiliary model parameters minimizes a respective loss associated with a respective auxiliary domain of the at least one auxiliary domain with respect to the set of current model parameters.

In example methods, in combination with any of the above features, the set of primary model parameters minimizes a loss associated with the at least one set of auxiliary model parameters and at least one of the primary domain and the at least one auxiliary domain with respect to the current model parameters.

In example methods, in combination with any of the above features, the steps of determining at least one set of auxiliary model parameters, determining a set of primary model parameters and updating the neural network model are repeated until at least one of a gradient descent step size for the second optimization is below a threshold and a maximum number of gradient descent steps is reached.

In example methods, in combination with any of the above features, at least one of the at least one first optimization step comprises at least one gradient descent step and the second optimization step comprises a gradient descent step.

In example methods, in combination with any of the above features, the one or more data points of the primary domain comprise or are divided into a first set of data points for training the neural network model, a second set of data points for validating the neural network model and a third set of data points for testing the neural network model.

In example methods, in combination with any of the above features, the neural network model is trained on the one or more data points of the primary domain being a first primary domain in a first step, and wherein the trained neural network model is subsequently trained on data points of a second primary domain in a second step without accessing data points of the first primary domain in the second step.

In example methods, in combination with any of the above features, the neural network model is trained by empirical risk minimization (ERM).

In combination with any of the above features, a neural network may be trained in accordance with methods disclosed herein to perform the task in at least the first primary domain and the second primary domain.

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure. As used herein, “at least one of” one or more listed items is intended to include any one, two, or more of the listed items, in any combination, up to and including all of such items, to the extent practicable.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method for training a neural network model for sequentially learning a plurality of domains associated with a task, the computer-implemented method comprising:
determining at least one set of auxiliary model parameters by simulating at least one first optimization step based on a set of current model parameters and at least one auxiliary domain, wherein the at least one auxiliary domain is associated with a primary domain comprising one or more data points for training a neural network model;
determining a set of primary model parameters by performing a second optimization step based on the set of current model parameters and the primary domain and based on the at least one set of auxiliary model parameters and at least one of the primary domain and the at least one auxiliary domain; and
updating the neural network model with the set of primary model parameters.

2. The computer-implemented method of claim 1 further comprising:
generating the at least one auxiliary domain from the primary domain;
wherein the generating the at least one auxiliary domain from the primary domain comprises modifying the one or more data points of the primary domain via data manipulation; and
wherein the at least one auxiliary domain comprises the one or more modified data points.

3. The computer-implemented method of claim 2, wherein the data manipulation is performed automatically.

4. The computer-implemented method of claim 2, wherein the generating the at least one auxiliary domain from the primary domain comprises selecting the one or more data points from the primary domain.

5. The computer-implemented method of claim 2,
wherein the modifying the one or more data points of the primary domain via data manipulation comprises automatically and/or randomly selecting one or more transformations from a set of transformations; and
wherein each auxiliary domain of the at least one auxiliary domain is defined by one or more respective transformations of the set of transformations.

6. The computer-implemented method of claim 2, wherein the data manipulation comprises at least one image transformation; and
wherein the at least one image transformation comprises at least one of a photometric and a geometric transformation.

7. The computer-implemented method of claim 1, wherein the second optimization step employs a regularizer having a first objective of avoiding catastrophic forgetting and a second objective of encouraging domain adaptation.

8. The computer-implemented method of claim 1, wherein the second optimization step employs a loss function having terms associated with task learning, avoiding catastrophic forgetting, and encouraging domain adaptation.

9. The computer-implemented method of claim 8, wherein the loss function is used for optimization of the model via gradient descent.

10. The computer-implemented method of claim 1, wherein a loss function associated with the second optimization step comprises:
(i) a first loss function associated with the set of current model parameters and the primary domain; and
one or more of:
(ii) a second loss function associated with the at least one set of auxiliary model parameters and the primary domain, or
(iii) a third loss function associated with the at least one set of auxiliary model parameters and the at least one auxiliary domain.

11. The computer-implemented method of claim 1, further comprising:
initializing the neural network model, wherein initializing the neural network model comprises setting model parameters of a pre-trained neural network model as initial model parameters for the neural network model to fine-tune the pre-trained neural network model.

12. The computer-implemented method of claim 1, further comprising:
selecting a first sample or a first batch of samples from the auxiliary domain for the determining at least one set of auxiliary model parameters; and
selecting a second sample or a second batch of samples from the primary domain and at least one of selecting a third sample or a third batch of samples from the primary domain and selecting a fourth sample or a fourth batch of samples from the at least one auxiliary domain for the determining a set of primary model parameters.

13. The computer-implemented method of claim 1,
wherein a set of auxiliary model parameters of the at least one set of auxiliary model parameters minimizes a respective loss associated with a respective auxiliary domain of the at least one auxiliary domain with respect to the set of current model parameters.

14. The computer-implemented method of claim 1,
wherein the set of primary model parameters minimizes a loss associated with the at least one set of auxiliary model parameters and at least one of the primary domain and the at least one auxiliary domain with respect to the current model parameters.

15. The computer-implemented method of claim 1, wherein the steps of determining at least one set of auxiliary model parameters, determining a set of primary model parameters, and updating the neural network model are repeated until at least one of a gradient descent step size for the second optimization is below a threshold and a maximum number of gradient descent steps is reached.

16. The computer-implemented method of claim 1, wherein at least one of the at least one first optimization step comprises at least one gradient descent step and the second optimization step comprises a gradient descent step.

17. The computer-implemented method of claim 1, wherein the one or more data points of the primary domain include or are divided into a first set of data points for training the neural network model, a second set of data points for validating the neural network model and a third set of data points for testing the neural network model.

18. The computer-implemented method of claim 1,
wherein the neural network model is trained on the one or more data points of the primary domain being a first primary domain in a first step, and wherein the trained neural network model is subsequently trained on data points of a second primary domain in a second step without accessing data points of the first primary domain in the second step.

19. The computer-implemented method of claim 18,
wherein the neural network model is trained by empirical risk minimization (ERM).

20. A neural network trained in accordance with the method of claim 18 to perform the task in the first primary domain and the second primary domain.

21. A method for performing a task in at least a first primary domain, the method comprising:
performing, by a neural network model trained on the first primary domain, the task in the first primary domain; and
performing, by the trained neural network model trained on the first primary domain and fine-tuned to a second primary domain, the task in the first primary domain or the second primary domain;
wherein the neural network model is fine-tuned by:
determining at least one set of auxiliary model parameters by simulating at least one first optimization step based on a set of current model parameters and at least one auxiliary domain, wherein the at least one auxiliary domain is associated with the second primary domain, wherein the second primary domain comprises one or more data points for training the neural network model;
determining a set of primary model parameters by performing a second optimization step based on the set of current model parameters and the second primary domain and based on the at least one set of auxiliary model parameters and at least one of the second primary domain and the at least one auxiliary domain; and
updating the neural network model with the set of primary model parameters.

22. The method of claim 21, wherein the neural network model is fine-tuned to perform the task in the second primary domain without accessing data points of the first primary domain.

23. An apparatus for training a neural network model comprising:
a non-transitory computer-readable medium having executable instructions stored thereon for causing a processor and a memory to perform a method comprising:
determining at least one set of auxiliary model parameters by simulating at least one first optimization step based on a set of current model parameters and at least one auxiliary domain, wherein the at least one auxiliary domain is associated with a primary domain comprising one or more data points for training a neural network model;
determining a set of primary model parameters by performing a second optimization step based on the set of current model parameters and the primary domain and based on the at least one set of auxiliary model parameters and at least one of the primary domain and the at least one auxiliary domain; and
updating the neural network model with the set of primary model parameters.

24. A system for training a neural network model comprising:
a processor;
a memory; and
computer-executable instructions stored on a non-transitory computer-readable medium for causing the processor to perform a method comprising:
determining at least one set of auxiliary model parameters by simulating at least one first optimization step based on a set of current model parameters and at least one auxiliary domain, wherein the at least one auxiliary domain is associated with a primary domain comprising one or more data points for training a neural network model;
determining a set of primary model parameters by performing a second optimization step based on the set of current model parameters and the primary domain and based on the at least one set of auxiliary model parameters and at least one of the primary domain and the at least one auxiliary domain; and
updating the neural network model with the set of primary model parameters.
